(19) United States
(12) Patent Application Publication
(10) Pub. No.: US 2003/0204536 A1
(43) Pub. Date: Oct. 30, 2003

(54) Technique for automatically associating desktop data items

(76) Inventors: Dhananjay V. Keskar, Beaverton, OR (US); Dean J. Sanvitale, Hillsboro, OR (US); Mic Bowman, Beaverton, OR (US); Robert Adams, Oswego, OR (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/445,127

(22) Filed: May 27, 2003

Related U.S. Application Data
(63) Continuation of application No. 09/608,631, filed on Jun. 30, 2000.

(51) Int. Cl. G06F 12/00

(52) U.S. Cl. 707/200

(57) ABSTRACT

A method of automatically associating data items residing in diverse applications, including, but not limited to: file system explorer, outlook, email and Web Browser applications that are executable in a host computer system with a data item selected by a user from one of the diverse application, said method comprising: monitoring incoming data items from the diverse applications; creating and maintaining meta-data which stores data items in a compact form, by associating incoming data items from the diverse applications with previously created meta-data of related data items and creating new meta-data for incoming data items not related to items contained in previously created meta-data; locating and displaying data items related to a data item selected by a user upon a command by said user; and updating the meta-data for the displayed data items in response to a user command.

### CROSS-REFERENCE TO RELATED APPLICATION

The present application is a continuation of application Ser. No. 09/608,631 filed on Jun. 30, 2000, the contents of which are incorporated by reference herein.

### BACKGROUND OF THE INVENTION

1. Field of the Invention

The present invention relates to a technique for associating various desktop items, such as files, e-mail messages, tasks, notes, contacts, and web pages, with other such items using an automatic, interactive, example-based query combined with user-controlled organization.

2. Description of the Related Art

Several applications exist for providing the ability to effect conceptual association between desktop items. These applications, for example, “The Brain”, usually maintained a directed graph with items as nodes and associations as arcs and display them as such. They also provide the intelligence to accept drag-drops from a wide range of desktop environments and to determine certain item properties, such as type, name, location, etc. They may also provide the ability to display in item appropriately based on their awareness of these properties.

Several applications, for example, Outlook, provide context menus, toolbar buttons, and menu items for showing “related items”, that is, items that are associated with a selected item and some way, for example, the same subject/thread. However, the user has no control over items considered as being associated with the selected item. Furthermore, the association only involves items within the application itself.

Several applications, for example, Enfish, OneSpace, or AltaVista client portal, provide a desktop wide data monitoring and indexing service. In the case of Enfish, this is only used within the application to gather certain items and display them together, for example, inbox, tasks, or contacts, or to provide the ability to search desktop items containing certain keywords. In the case of AltaVista, the data is used for showing items which are related to a web page as well as to allow keyboard-based searches of desktop data.

However, none of these above noted applications allow access to a consistent “association” functionality from diverse application environments nor do they use example-based query's using the selected items to provide candidates for association nor do they combine automatic suggestions for associations with explicit user-controlled association as in the present invention.

### BRIEF DESCRIPTION OF THE DRAWINGS

The foregoing and a better understanding of the present invention will become apparent from the following detailed description of example embodiments and the claims when read in connection with the accompanying drawings, all forming part of the disclosure of this invention. While the foregoing and following written and illustrated disclosure focuses on disclosing example embodiments of the invention, it should be clearly understood that the same is by way of illustration and example only and the invention is not limited thereto. The spirit and scope of the present invention are limited only by the terms of the appended claims.

The following represents brief descriptions of the drawings, wherein:

FIG. 1 illustrates one example implementation technique in accordance with the present invention.

FIG. 2 illustrates element 100 in greater detail and FIG. 3 illustrates element 200 in greater detail.

### DETAILED DESCRIPTION

Before beginning a detailed description of the subject invention, mention of the following is an order. When appropriate, like reference numerals or characters may be used to designate identical, corresponding, or similar components in differing drawing figures. Furthermore, in the detailed description of followed, example sizes/models/values/ranges may be given, although the present invention is not limited thereto. So furthermore, well-known power connections and other components may not be shown within the drawing figures for simplicity of illustration and discussion and so as not to obscure the invention.

With the present invention, a user can select a desktop item in any of the various graphical application environments, such as a file system Explorer, a mail item display, a web browser, etc., and utilize the provided user interface mechanisms, such as a context menu, toolbar button, etc., to access the auto-associate functionality.

Furthermore, with the present invention, if there is no current association for the item, then the selected item may be considered as example and used as the basis of a query to display items similar to the selected item as suggestions. The user can then choose some items, thus explicitly stating that they are associated with the selected item. Additional desktop items can also be explicitly added or removed. An association is then created between the selected item and the items explicitly added by the user.

With the present invention, if there is an association for the selected item, then the user-associated items are displayed and these items, along with the selected items, are used as the basis of a query to display items similar thereto. Various kinds of items, such as files, mail items such as tasks, messages, contacts, web pages, etc., can be associated.

With the present invention, the association mechanism user interface spans across applications to cover various desktop items. The user does not have to open a special-purpose application to access and manage the associations and accordingly, no time is wasted in hunting for the window of the special application on a cluttered desktop and managing the placement and window focus such that the item of interest can be dragged onto the associating application.

The present invention allows a way of finding and display desktop items that span associations and are similar to the selected items, taking into account content, attributes, etc. This auto-association is quite useful and at the same time, users are not prohibited from explicitly controlling the associated items. In addition, various kinds of items residing in diverse applications can be associated.

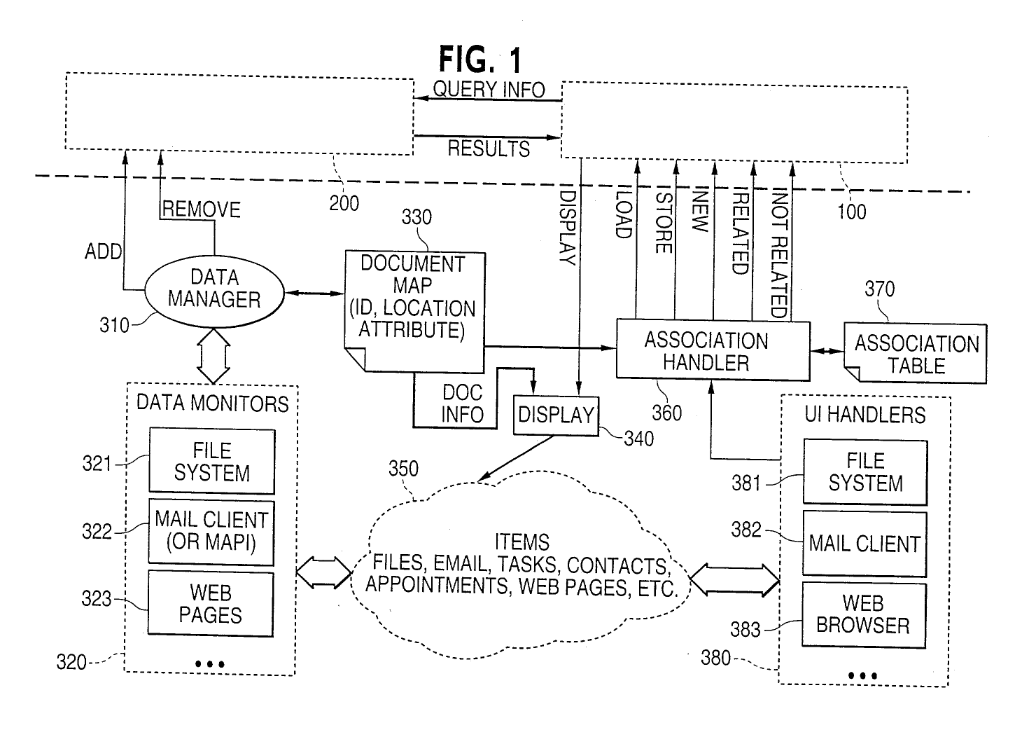

FIG. 1 illustrates one example implementation technique in accordance with a present invention. It is to be noted that FIG. 1 is neither a block diagram nor a flowchart but rather the boxes represent functions performed in accordance with the illustrated technique and the flow of data and signals. Furthermore, in the description to follow, documents are referred to. However, the present invention is not limited to documents per se but rather can be used with any group of items capable of being classified as to their relevance.

In FIG. 1, element 200 is a mechanism for fast retrieval and ranking of documents relevant to a query based on example documents while element 100 is an interactive mechanism for automatically finding and organizing items similar to example items. These elements will be discussed in detail below.

The data manager 310 interfaces with element 200 to create and maintain meta-data about the various items. This allows element 200 to process queries and return relevant results. The data manager 310 also maintains a two-white document map, assigning a unique ID to each document and maintaining information about its location, access attributes, etc.

The data monitors 320 recognizes and handles different kinds of data items and passes the resultant information to the data manager 310. The data monitors 320 interface with various subsystems, noting currently available items, as well as monitoring new arrivals, updates, and deletions of items.

The data monitors 320 includes a file system monitor 321, a mail client monitor 322, and a web pages monitor 323 and possibly other monitors for other kinds of items. The file system monitor 321 tracks editions and deletions of files in the file system. The mail client monitor 322 user is the mail client API (Application Programming Interface) or generic MAPI (Messaging Application Programming Interface) protocol to monitor the user's e-mail messages, tasks, appointments, contacts, etc. The web pages monitor 323 tracks the web browser navigation and page downloads.

The user interface handlers 380 provided user interface mechanisms to access the association functionality. The mechanisms are contained in different subsystems, that is, application environments, using appropriate mechanisms as needed. The user interface handlers 380 include a file system 381, for example, on Windows desktops, an entry in the Send To Folder in the “Windows” directory, which is a shortcut to an executable application. The user interface handlers 380 also includes a mail client 382 which has the capability of providing a plug-in or add-in program which can add desired user interface elements such as context menus, toolbars, etc. A web browser 383, such as Internet Explorer, provides a mechanism to add “web accessories” such as toolbar items as well as custom context menus.

The association handler 360 accepts information about the selected item from the user interface handlers 380, looks up the document information in the document map 330, and looks up an entry for the selected item in the association table 370. The association handler 36 to interfaces with element 100 to open the organization of associated items or alternatively creates a new incidence with the selected item becoming a “related” item and then updates the association table. The association handler 360 then automatically stores the organization.

If a particular item in the organization is to be displayed, the display 340 determines the location, its attribute, and then takes the needed steps or issues the necessary commands to the appropriate subsystem to display the item.

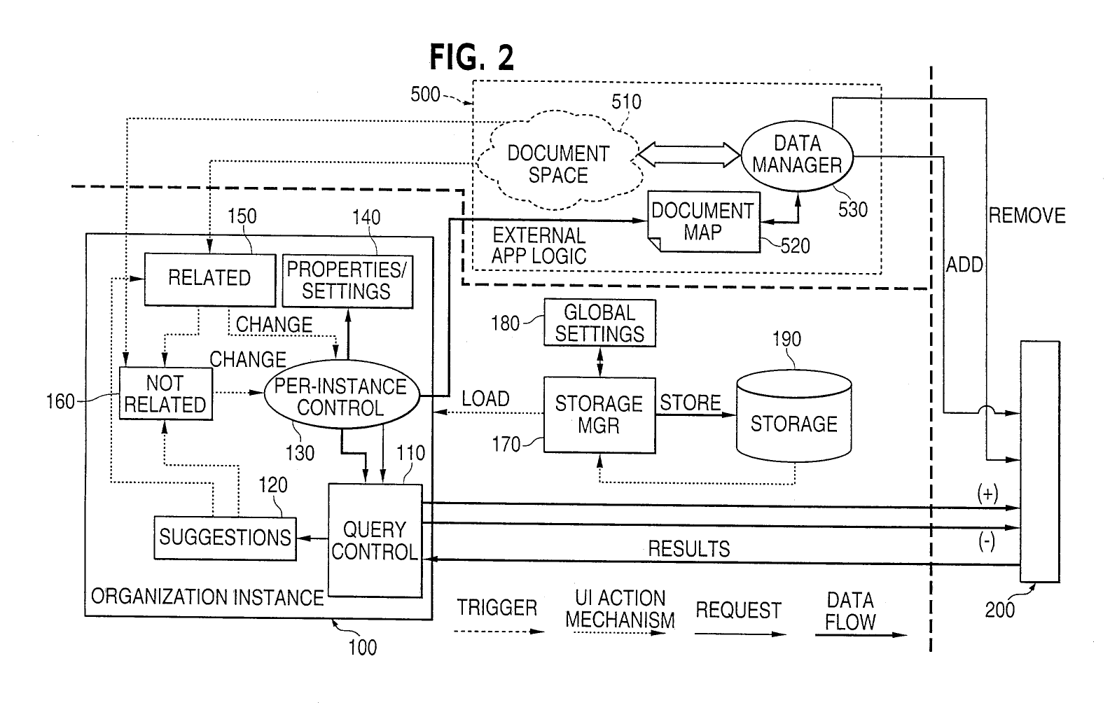

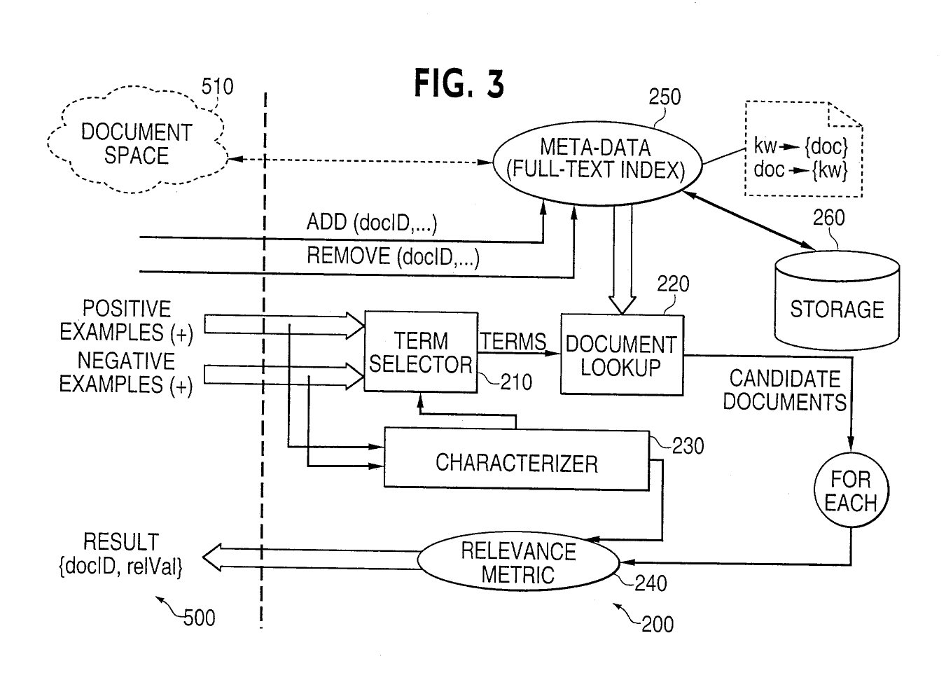

Included in FIG. 2 is a block 100 labeled organization instance. Included in block 100 is a query control 110, a suggestions block 120, a per-instance control 130, a properties/settings block 140, a related block 150, and a not related block 160. Also included in FIG. 2 is a storage manager 170, a global settings unit 180, a storage unit 190, and an element 200, which is illustrated in FIG. 3 in detail, for fast retrieval and ranking of documents relevant to a query based on example documents.

FIG. 2 also includes an external application logic block 500, containing a document space 510, a document map 520, and a data manager 530.

Included in FIG. 3 is the element 200 of FIG. 2. The element 200 includes a term selector 210, a document lookup 220, a characterizer 230, a relevance metric 240, a meta-data block 250, and a storage unit 260.

The organization instance block 100 includes the suggestions, related, and not related blocks 120, 150, and 160. Each of these blocks corresponds to groupings of documents. The suggestions documents are those documents which have been selected by the present invention as being relevant to the related documents. The related documents are those documents selected by a user as being related to each other and may include documents previously located in the suggestions grouping and transferred by the user to the related grouping. The not related grouping are those documents selected by a user as not being related to the related grouping of documents and may include documents previously contained in the related grouping as well as documents contained in the suggestions grouping.

In operation, a user interface, such as a graphic user interface, may contain three “panes” respectively corresponding to the suggestions, related, and not related blocks 120, 150, and 160. The user then may drag and drop documents from one pane to another as he or she sees fit. Normally, the user would open one of the documents in the suggestions pane and based on the user's review, would move that document to either the related or not related pane.

Note that in FIG. 2, each organization instance 100 corresponds to a distinct organization in accordance with the present invention. That is, in accordance with the present invention, there may be several distinct organizations of documents, each organization corresponding to a particular subject matter.

The user interface allows for the user to move documents from one group of documents in one instance to another group of documents in the same instance, such as moving a document from the suggestions group to the related group, or allows the user to move documents from one group of documents in one instance to another group of documents in another instance, such as from the suggestion group in one instance to the related group in another instance.

The per instance control 130 is a centralized piece of logic that changes things based upon the manipulations of the user interfacing with the user interface. The query control 110 provides positive and negative examples of documents to the element 200 and based on these positive and negative examples, as will be discussed in detail below, the element 200 provides “results” to the query control 110. These “results” are documents which are believed to be related to the related grouping of documents 150 and these documents are provided to the user in the suggestions pane for review by the user.

Based on the selections of the user, that is, the user moving a document from the suggestions grouping 120 to either the related or not related groupings 150 or 160 or moving a document from the related grouping 150 to the not related grouping 160 or vice versa, the external application logic 500, in conjunction with the data manager 530 and document map 520 and document space 510, provides information to the element 200 as to whether to add or remove a document.

The property/settings box 140 interfaces the user with the per-instance control 130 and the query control 110 and may include such operations as allowing the user to select the number of documents to be provided in the suggestions grouping 120 or which of the three panes of the groupings are to be visible on the user interface.

The external application logic 500 works in the background as an interface between the organization instance block 100 and the element 200. For example, if a user double clicks a particular document that the user wishes to open and review, the per-instance control 130 sends a signal to the document map 520. The document map 520 tells the data manager 530 where the selected document is located, for example, that the selected document is a particular e-mail message. This allows the data manager 530 to locate the document in the document space 510 and display it on the user interface. The data manager 530 is a particular way of looking at or depicting 310 in the detailed view of block 100. Element 330 corresponds to 520, and element 510 corresponds to 350. The data manager also manages the addition and removal of metadata about the documents in the document space 510, to and from element 200. It can be doing this in the background.

It is to be noted that the document map 520 does not store the documents themselves but rather serves as an index to allow the data manager 530 to locate the documents contained in the document space 510. In the present invention, the documents contained in the document space 510 are not limited to those documents in one particular application but rather may include documents contained in any application disposed in a user's computer. That is, the technique in accordance with the present invention may search all of the documents stored in all of the folders of the user's computer to locate those documents which are relevant to the example documents or documents.

The present invention continuously updates the suggestions based upon the manipulation by the user. That is, as noted in FIG. 2, if the user moves a document to either the related group 150 or the not related group 160, the change in the document grouping is inputted to the per-instance control 130 which in turn transfers this information to the element 200 via the query control 110. The element 200 in turn may make new suggestions or alter the previously provided suggestions based on the change in the document grouping. This allows for the user interface data to be continually updated interactively in response to the manipulation by the user. That is, a new search does not have to be initiated by the user.

The storage manager 170 controls the storage of the organization instances 100 in the storage unit 190 in conjunction with the global settings unit 180.

Referring now to FIG. 3, which illustrates in detail the features of element 200 of FIG. 2, the purpose of element 200 is to use multiple, for example, positive and negative, example documents as the basis for a query by mathematically representing the input set and then testing the mathematical representation by finding commonality amongst the documents in the query example set and characterizing the individual documents in the query example set. Element 200 may then use term selection and index lookup for the selected terms to quickly reduce the total number of documents to a list of documents which are candidates for being relevant to the query. Element 200 may then calculate the meaningful relevance of each candidate document with respect to the input set and assign a “relevance score”, for example, a number between zero and one hundred, to each document.

As shown in FIG. 3, meta-data 250 with respect to the document space 510 is stored in storage unit 260 for later use. The stored information allows element 200 to form a set of documents which contain a given word or term or alternatively, determine the set of words or terms and their occurrence count in a given document. The meta-data is maintained by the external application logic 500 which includes the document space 510 and which performs the additions and deletions as appropriate. This can be put in or controlled by data manager 930. In FIG. 3, docID refers to a unique identifier for each document which is provided by the external application logic 500.

The query control 110, in a given organization instance 100, external application logic 500 provides a set of positive and negative example documents for each organization instance. The documents are analyzed to extract terms along with their occurrence counts for each document. The term selector 210 uses this information along with the document length and the most important terms from each document to deduce the most important terms from the whole input set.

The characterizer 230 compares each of the input set documents with the entire input set and adjusts the mathematical “weight” or value of terms in the document based on this information. This feedback essentially adjusts the “weight” or importance assigned to each document when calculating the relevance of the candidate documents.

A predetermined parameterized number of terms may be fed from the term selector 210 to the document lookup 220. During document lookup, an index lookup is performed for each of the selected terms so as to find the set of documents that contain the term. Terms that index into more than a parameterized percentage of the total number of documents are considered to be too common to be useful in finding documents relevant to the set of input documents and may therefore be ignored. Such ignored terms may be replaced with additional terms if available.

The union of all such document sets, (that is, for each term, the set of documents that contain the term), for each of the selected terms is the set of documents which are candidates for being relevant to the input documents. Discarding common terms and the documents that they index helps keep the set of candidate documents at an optimal size for calculating the actual relevance.

For each of the candidate documents, the relevance value relVal is calculated by the relevance metric 240, taking into account the mathematical adjustment performed by the characterizer 230. The result is a set of docIDs and their corresponding relVal values which are forwarded to the external application logic 500 for use with the organization instance 100.

Given a group of example documents, each document can be represented as terms and their occurrence count in the document. Term selection can then be performed in several ways. The simplest mechanism is to combine the occurrence counts of the terms across all of the documents, sort them in descending order of the total count, and then consider the top predetermined number of these sorted terms. Various algorithms may then be used to effect document lookup and characterization and relevance calculations.

This concludes the detailed description of the invention. Although the present invention has been described with reference to add illustrated embodiment, it should be under said that numerous other modifications and embodiments can be devised by those skilled in the art that will fall within the spirit and scope of the principles of this invention. More particularly, reasonable very Asians and modifications are possible in the component parts and/or arrangements of the subject combination within the scope of the foregoing disclosure, drawings, and appended claims without departing from the spirit of the invention. In addition to variations and modifications in the component parts and/or arrangements, alternative uses will be apparent to those skilled in the art.

What is claimed is:

1. A method of automatically associating data items residing in diverse applications, including, but not limited to: file system explorer, outlook, email and Web Browser applications that are executable in a host computer system with a data item selected by a user from one of the diverse application, said method comprising:
monitoring incoming data items from the diverse applications;
creating and maintaining meta-data which stores data items in a compact form, by associating incoming data items from the diverse applications with previously created meta-data of related data items and creating new meta-data for incoming data items not related to items contained in previously created meta-data;
locating and displaying data items related to a data item selected by a user upon a command by said user; and
updating the meta-data for the displayed data items in response to a user command.

2. The method as claimed claim 1, wherein said monitoring incoming data items comprises monitoring additions and deletions of files in a user file system.

3. The method as claimed in claim 1, wherein each of the data items monitored indicates one of a file, an email, and a mail item such as a task, a note, contact information and a web page.

4. The method as claimed in claim 1, wherein the data items monitored indicate web browser navigation and page downloads.

5. The method as claimed in claim 1, wherein said creating and maintaining meta-data about monitored data items comprises searching a database to locate at least one data item which is related to an incoming data item based on a predetermined criterion, said predetermined criterion comprising assigning a normalized relevance score for each monitored data item based on each data item's relevance and including said monitored data item having a relevance score greater than a predetermined threshold in an association group containing said at least one data item.

6. An apparatus for automatically associating desktop data items residing in diverse applications, including, but not limited to: file system explorer, outlook, email and Web Browser applications that are executable in a host computer system, with a data item selected by a user from one of the diverse application, said apparatus comprising:
a data monitor to monitor incoming data items from the diverse applications;
a data manager, interfacing with said data monitor, to create and maintain meta-data which stores data items in a compact form, by associating incoming data items from said data monitor with previously created meta-data of related data items and creating new meta-data for incoming data items not related to items contained in previously created meta-data;
a display and a user interface, interfacing with said data manager, to locate and display data items related to a data item selected by a user upon a command by the user; and
an association handler, interfacing with said user interface and data manager, to update the meta-data for the displayed data items in response to a user command from said user interface.

7. The apparatus as claimed in claim 6, wherein said data monitor includes a file system monitor to monitor additions and deletions of files in a user file system.

8. The apparatus as claimed in claim 6, wherein said data monitor includes a mail client monitor to monitor at least one of a user's email, files, tasks, appointments, and contacts.

9. The apparatus as claimed in claim 6, wherein the data monitor includes a web page monitor to monitor web browser navigation and page downloads.

10. The apparatus as claimed in claim 6, further comprising a first mechanism to retrieve and rank documents relevant to a query and a second mechanism to automatically find and organize data items similar to example items, said first mechanism and said second mechanism being disposed between said data manager and association handler and said second mechanism interfacing with said display, said first and second mechanism searching a database to locate at least one data item which is related to an incoming data item based on a predetermined criterion, said predetermined criterion comprising assigning a normalized relevance score for each monitored data item based on each data item's relevance and including said monitored data item having a relevance score greater than a predetermined threshold in an association group containing said at least one data item.

11. A storage medium to store a program that can be integrated into an operating system or plugged-in another program in a host computer system for automatically associating desktop data items residing in diverse applications, including, but not limited to: file system explorer, outlook, email and Web Browser applications running in the host computer system with a data item selected by a user from one of the diverse application that, when executed by the host computer system, resulting in the following:
monitoring incoming data items from the diverse applications;
creating and maintaining meta-data which stores data items in a compact form, by associating incoming data items with previously created meta-data of related data items and creating new meta-data for incoming data items not related to data items contained in previously created meta-data;
locating and displaying data items related to a data item selected by a user upon a command by said user; and
updating the meta-data for the displayed data items in response to a user command.

12. The storage medium as claimed in claim 11, wherein said monitoring incoming data items comprises monitoring additions and deletions of files in a user file system.

13. The storage medium as claimed in claim 11, wherein each of the data items monitored indicates one of a file, an email, and a mail item such as a task, a note, contact information and a web page.

14. The storage medium as claimed in claim 11, wherein the data items monitored include web browser navigation and page downloads.

15. The storage medium as claimed in claim 11, wherein said creating and maintaining meta-data which stores data items in a compact form comprises searching a database to locate at least one data item which is related to an incoming data item based on a predetermined criterion, said predetermined criterion comprising assigning a normalized relevance score for each monitored data item based on each data item's relevance and including said monitored data item having a relevance score greater than a predetermined threshold in an association group containing said at least one data item.
